(19) United States
(12) Patent Application Publication
(10) Pub. No.: US 2026/0138686 A1
(43) Pub. Date: May 21, 2026

(54) CARGO BODY ASSEMBLY FOR MOBILITY

(71) Applicants: Hyundai Motor Company, Seoul (KR); Kia Corporation, Seoul (KR)

(72) Inventors: Kang Chul Lee, Hwaseong-si (KR); Sukjoo Hong, Hwaseong-si (KR); Ju Chul Kim, Hwaseong-si (KR); Do Hoi Kim, Hwaseong-si (KR)

(21) Appl. No.: 19/319,316

(22) Filed: Sep. 4, 2025

(30) Foreign Application Priority Data
Nov. 18, 2024 (KR) 10-2024-0163823

(51) Int. Cl. B62D 33/04

(52) U.S. Cl. CPC B62D 33/044

(57) ABSTRACT

A cargo body assembly of a mobility can include a cargo under body configured to be connected to a vehicle body, a cargo upper body connected to the cargo under body, and the cargo upper body includes hybrid members, wherein each of the hybrid members includes injection reinforcing material molded on an outer surface of a tubular part, wherein the hybrid members are disposed along a front-rear direction, a vehicle width direction, and a vertical direction of the vehicle body, reinforcement members connected to the cargo upper body along the front-rear direction and the vehicle width direction of the vehicle body, and outer plates including plastic composite material connected to the cargo upper body and the reinforcement members.

### CROSS-REFERENCE TO RELATED APPLICATIONS

This application claims priority to and the benefit of Korean Patent Application No. 10-2024-0163823 filed with the Korean Intellectual Property Office on Nov. 18, 2024, the entire contents of which are incorporated herein by reference.

### TECHNICAL FIELD

The present disclosure relates to a cargo body assembly for a mobility.

### BACKGROUND

Recently, the vehicle industry has been introducing a new concept of future mobility vision for realizing a dynamic future city centered on humans. One of these future mobility solutions is the Purpose Built Vehicle (PBV) as a purpose-based mobility.

An example of a PBV is an electric vehicle (EV)-based environment-friendly mobility vehicle. These PBVs can provide various customized services to users. PBV can be configured in various forms depending on the type of customized service.

For example, the PBV can be used as a hailing type vehicle to transport occupants by configuring cabins in the front and rear of the vehicle body. In addition, the PBV can also be utilized as a cargo type vehicle (which those skilled in the art typically refer to as a delivery type) that has a cabin in the front part of the vehicle body and a cargo body assembly in the rear part of the vehicle body.

The cargo body assembly has an underbody and an upper body assembled to the underbody. The upper body mainly uses sandwich panels because of the ease of assembly.

However, because this conventional cargo body assembly is manually assembled on the underbody, it is not suitable for mass production of cargo type PBV. In addition, because conventional cargo body assemblies are manufactured through processes such as pressing, painting, and welding, the number of manufacturing processes and production costs of cargo body assemblies may increase.

The information contained in this background section is intended to promote understanding of the background of the present disclosure and may include matters that are not conventional art already publicly known, available, or in use.

### SUMMARY

The present disclosure relates to a vehicle body for a mobility, and more particularly, the present disclosure relates to a cargo body assembly for a mobility.

An embodiment of the present disclosure can provide a cargo body assembly for a mobility that does not require processes such as pressing, painting, and welding and can be mass produced.

An embodiment of the present disclosure can provide a cargo body assembly of a mobility that can secure body strength and outer panel strength.

A cargo body assembly of a mobility according to a disclosed example embodiment of the present disclosure may include a cargo under body connected to the rear of a vehicle body, a cargo upper body connected to the cargo under body, and the cargo upper body where hybrid members, in which injection reinforcing material is molded on an outer surface of a tubular part, are connected along the front-rear direction, vehicle width direction, and vertical direction of the vehicle body, reinforcement members connected to the cargo upper body along the front-rear direction and the width direction of the vehicle body, and outer plates of plastic composite material connected to the cargo upper body and the reinforcement members.

The hybrid members may be connected along the front-rear direction, width direction, and vertical direction of the vehicle body through a plurality of joint members.

The cargo upper body may include pillar hybrid members connected along the vertical direction on both sides of the cargo under body along the width direction of the vehicle and arranged along the front-rear direction of the vehicle body, roof side hybrid members connected along the front-rear direction of the vehicle body to the upper portion of the pillar hybrid members, a front roof hybrid member connected along the vehicle width direction to the upper portion of the pillar hybrid members positioned at the front, and a rear roof hybrid member connected along the vehicle width direction to the upper portion of the pillar hybrid members positioned at the rear.

The pillar hybrid members may be bolted to mounting brackets mounted on both sides along the vehicle width direction of the cargo under body.

The cargo upper body may include pillar hybrid members connected along the vertical direction on both sides of the cargo under body along the vehicle width direction and arranged along the front-rear direction of the vehicle body, a front side reinforcement bracket that is riveted to the pillar hybrid members positioned at the front and bonded to a front outer plate and a side outer plate, and a front side garnish member rivetted and connected to the front outer plate, the side outer plate and the front side reinforcement bracket.

The cargo upper body may include a roof side upper reinforcement bracket that is bonded to the roof side hybrid members and bonded to a roof outer plate and a side outer plate, a roof side lower reinforcement bracket connected to the roof side hybrid members, and a roof side garnish member that is connected to the roof side upper reinforcement bracket and the roof outer plate by riveting, and is connected to the roof side upper reinforcement bracket, the roof side lower reinforcement bracket and the side outer plate by riveting.

The cargo upper body may include a front roof upper reinforcement bracket that is bolted connected to the front roof hybrid member and adhered to a roof outer plate, a front roof lower reinforcement bracket bolted to the front roof hybrid member and bonded to a front outer plate, and a front roof garnish member that is rivetted and connected to the roof outer plate and the front roof upper reinforcement bracket, and is rivetted and connected to the front outer plate and the front roof lower reinforcement bracket.

The reinforcement members may include side reinforcement panels and side reinforcement pipes connected to the pillar hybrid members along the front-rear direction of the vehicle body.

The side reinforcement panels may be connected to the pillar hybrid members through side panel joint brackets.

The side reinforcement pipes may be connected to the pillar hybrid members through side pipe joint brackets.

The reinforcement members may further include a side support bracket connected to each of the side reinforcement pipes.

A side outer plate may be bonded to the side reinforcement panels and the side support bracket.

The reinforcement members may include front reinforcement panels and front reinforcement pipes connected along the vehicle width direction to pillar hybrid members positioned at the front.

The front reinforcement panels may be connected to the pillar hybrid members through front panel joint brackets.

The front reinforcement pipes may be connected to the pillar hybrid members through front pipe joint brackets.

The reinforcement members may further include a front support bracket connected to the upper and lower portions of the front reinforcement pipes respectively.

A front outer plate may be bonded to the front reinforcement panels and the front support bracket.

The reinforcement members may include roof reinforcing pipes connected to the roof side hybrid members along the vehicle width direction, and roof reinforcing panels connected to the front roof hybrid member and the rear roof hybrid member along the front-rear direction of the vehicle body.

The roof outer plate may be bonded to the roof reinforcing pipes and the roof reinforcing panels.

The cargo upper body may include spacer members connected to the pillar hybrid members and bonded to side outer plates.

The spacer members may be inserted into the injection reinforcing material of the pillar hybrid members and can be bolted connected to the injection reinforcing material.

For a cargo body assembly for a mobility according to an embodiment of the present disclosure, processes such as pressing, painting, welding, or any combination thereof are not required, and mass production can be possible.

For a cargo body assembly for a mobility according to an embodiment of the present disclosure, the body rigidity of the front, side and roof can be secured, and the bonding strength of the outer panels can be secured.

Advantages that can be obtained or expected due to an embodiment are directly or implicitly disclosed in the detailed description of the disclosed examples embodiments of the present disclosure. That is, various advantages predicted according to the disclosed example embodiments of the present disclosure will be disclosed in the detailed description that follows.

### BRIEF DESCRIPTION OF THE DRAWINGS

These drawings are intended for reference in explaining example embodiments of the present disclosure, and therefore, the technical ideas of the present disclosure are not necessarily limited to the accompanying drawings.

FIG. 1 is a side view illustrating a cargo body assembly of a mobility according to a disclosed example embodiment of the present disclosure.

FIG. 2 is a partial perspective view illustrating a cargo body assembly of a mobility according to a disclosed example embodiment of the present disclosure.

FIG. 3 is a partially exploded perspective view illustrating a cargo body assembly of a mobility according to a disclosed example embodiment of the present disclosure.

FIG. 4 is a perspective view illustrating a joint structure of a cargo under body and a cargo upper body applied to a cargo body assembly of a mobility according to a disclosed example embodiment of the present disclosure.

FIG. 5 is a perspective view illustrating a joint structure of a cargo under body and a cargo upper body applied to a cargo body assembly of a mobility according to a disclosed example embodiment of the present disclosure.

FIG. 6 is a cross-sectional view schematically illustrating a hybrid member applied to a cargo body assembly of a mobility according to a disclosed example embodiment of the present disclosure.

FIG. 7 is a cross-sectional view along line A-A of FIG. 2.

FIG. 8 is a cross-sectional view along line B-B of FIG. 2.

FIG. 9 is a cross-sectional view along line C-C of FIG. 2.

FIG. 10 is a side view illustrating a side reinforcing structure applied to a cargo body assembly of a mobility according to a disclosed example embodiment of the present disclosure.

FIG. 11 is a cross-sectional view along line D-D of FIG. 10.

FIG. 12 is a cross-sectional view along line E-E of FIG. 10.

FIG. 13 is a front view illustrating a front reinforcing structure applied to a cargo body assembly of a mobility according to a disclosed example embodiment of the present disclosure.

FIG. 14 is a cross-sectional view along line F-F of FIG. 13.

FIG. 15 is a cross-sectional view along line G-G of FIG. 13.

FIG. 16 is a top plan view illustrating a roof reinforcing structure applied to a cargo body assembly of a mobility according to a disclosed example embodiment of the present disclosure.

FIG. 17 is a cross-sectional view along line H-H of FIG. 16.

FIG. 18 is a cross-sectional view along line I-I of FIG. 16.

FIG. 19 is a drawing showing a joint structure of filler hybrid members and side outer plates applied to a cargo body assembly of a mobility according to a disclosed example embodiment of the present disclosure.

The drawings referenced above are not necessarily to scale, and can be understood as presenting rather simplified representations of various features illustrating principles of the present disclosure. For example, certain design features of an example embodiment of the present disclosure, including particular dimensions, direction, position, and shape, can be determined in part by a particular intended application and usage environment.

### DETAILED DESCRIPTION OF ILLUSTRATIVE EMBODIMENTS

Hereinafter, with reference to the attached drawings, example embodiments of the present disclosure will be described in detail so that a person having ordinary skill in the art to which the present disclosure pertains can easily practice an embodiment of the present disclosure. As those skilled in the art can realize, the described example embodiments may be modified in various different ways, without departing from the spirit or scopes of the present disclosure.

Terminology used herein is for the purpose of describing particular example embodiments and is not intended to necessarily limit the present disclosure. As used herein, singular forms can be intended to include the plural forms as well, unless the context clearly indicates otherwise.

It should also be understood that the terms “comprise” and/or “include” as used herein indicate the presence of stated features, integers, steps, operations, elements, and/or components, but do not preclude the presence or addition of one or more other features, integers, steps, operations, components, and/or groups thereof.

As used herein, the term “and/or” includes any and all combinations of one or more of the associated listed items.

In this specification, the term “connected”' indicates a physical relationship between two components where the components are directly connected to each other by welding, SPR (Self Piercing Rivet), FDS (Flow Drill Screw), structural adhesive, etc., or indirectly connected through one or more intermediate components.

As used herein, “vehicle”, “vehicular”, “automotive”, or other similar terms, as used herein generally can refer to passenger vehicles, sports cars, sport utility vehicles (SUVs), tractors, buses, trucks, and various commercial vehicles, including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources), for example.

Hereinafter, example embodiments of the present disclosure will be described in detail with reference to the attached drawings.

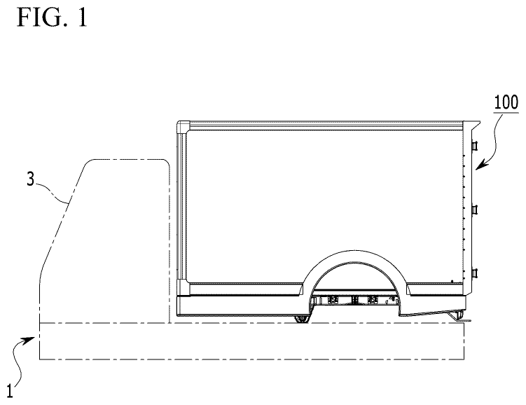

FIG. 1 is a side view illustrating a cargo body assembly of a mobility according to a disclosed example embodiment of the present disclosure.

Referring to FIG. 1, a cargo body assembly of a mobility 100 according to a disclosed example embodiment of the present disclosure may be applied to, for example, a vehicle body 1 of a purpose-based mobility vehicle (hereinafter referred to as “PBV”).

The PBV may be utilized as an electric car-based life module vehicle that provides various customized services to users during the time it takes to move from the departure point to the destination.

The vehicle body 1 of the PBV may be manufactured in various shapes and sizes depending on the intended use of the PBV.

In this specification, the reference direction for describing components described below may be set as the front-rear direction of the vehicle (e.g., the length direction or longitudinal direction of the vehicle), the vehicle width direction of the vehicle (e.g., the transverse direction), and the vehicle vertical direction (e.g., the height direction or up down direction).

In this specification, “upper end”, “upper portion”, or “upper surface” of a component can indicate an end, portion, or surface of a component that is relatively upper in the drawing, and “lower end”, “lower portion”, or “lower surface” of a component can indicate an end, portion, or surface of a component that is relatively lower in the drawing.

In this specification, an end of a component (e.g., one end or another (other) end, etc.) can denote an end of a component in any one direction, and an end portion of the component (e.g., one end portion) or other (another) end portion, etc.) can denote a portion of a component that includes that end.

The vehicle body 1 of the PBV can include, in one example, a front cabin 3 of a cab type configured in the front part.

A cargo body assembly of a mobility 100 according to a disclosed example embodiment of the present disclosure can be mounted on the rear portion of the vehicle body 1.

The PBV may be utilized as a cargo type or delivery type vehicle having a cargo room or luggage room formed in the rear part of the vehicle body 1 by a cargo body assembly of a mobility 100 according to a disclosed example embodiment of the present disclosure.

A cargo body assembly of a mobility 100 according to a disclosed example embodiment of the present disclosure may be connected to the rear part of the vehicle body 1 by a connecting unit.

The connecting unit here may be configured for various types of coupling, such as a configuration that is manually coupled with a mechanical configuration, a configuration that is coupled by the operation of a separate actuator, a configuration that can be coupled and/or released depending on the supply of external or internal power, including magnetic, etc. The configuration and operation of a “connecting unit” can be used to combine or disassemble one or more modules or frames, etc., are matters that are obvious to those skilled in the art, and thus a detailed description is omitted.

A cargo body assembly of a mobility 100 according to a disclosed example embodiment of the present disclosure can provide a structure that does not require processes such as pressing, painting, welding, or any combination thereof, and can be capable of mass production.

A cargo body assembly of a mobility 100 according to a disclosed example embodiment of the present disclosure can provide a structure capable of securing body strength and outer plate strength.

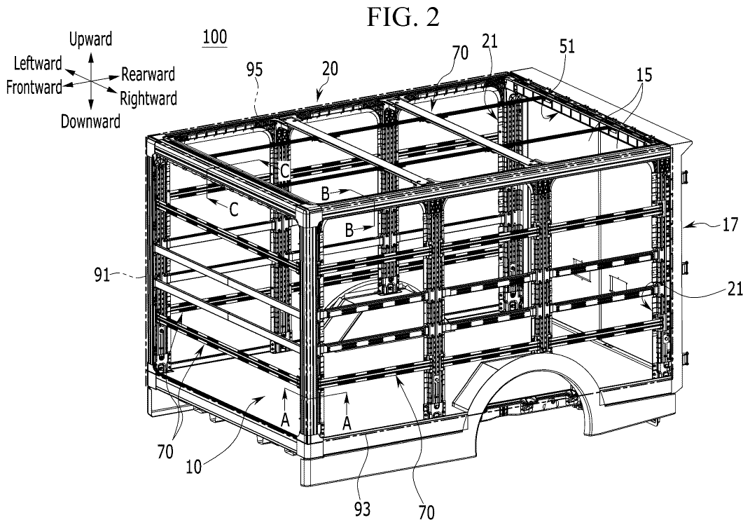

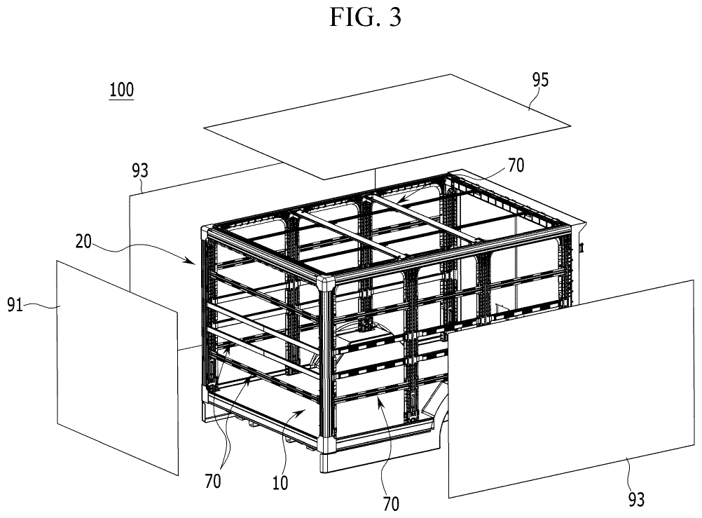

FIG. 2 is a partial perspective view illustrating a cargo body assembly of a mobility according to a disclosed example embodiment of the present disclosure. FIG. 3 is a partially exploded perspective view illustrating a cargo body assembly of a mobility according to a disclosed example embodiment of the present disclosure.

Referring to FIG. 1 to FIG. 3, a cargo body assembly of a mobility 100 according to a disclosed example embodiment of the present disclosure can include a cargo under body 10, a cargo upper body 20, reinforcement members 70, and outer plates 91, 93, and 95.

In a disclosed example embodiment of the present disclosure, the cargo under body 10 can be provided as a floor body of the cargo body assembly and can be connected to the rear portion of the vehicle body 1.

The cargo under body 10 can be connected to the rear of the vehicle body 1 by the connecting unit mentioned above.

In a disclosed example embodiment of the present disclosure, the cargo upper body 20 can be connected to the cargo under body 10 to form a cargo room or luggage room.

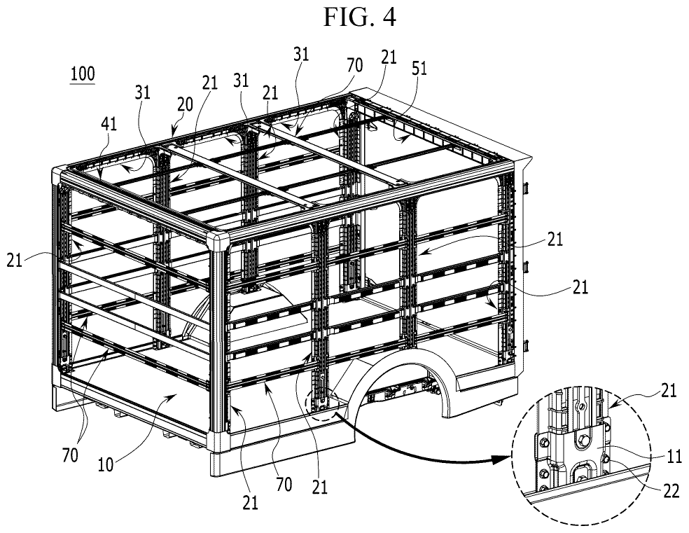

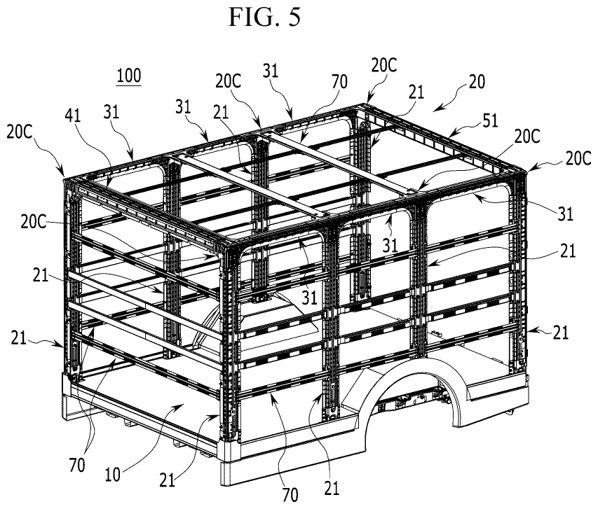

FIG. 4 is a perspective view illustrating a joint structure of a cargo under body and a cargo upper body applied to a cargo body assembly of a mobility according to a disclosed example embodiment of the present disclosure. FIG. 5 is a perspective view illustrating a joint structure of a cargo under body and a cargo upper body applied to a cargo body assembly of a mobility according to a disclosed example embodiment of the present disclosure.

Referring to FIG. 2 to FIG. 5, the cargo upper body 20 according to a disclosed example embodiment of the present disclosure can include a plurality of hybrid members 21, 31, 41, and 51 connected along front-rear direction, the vehicle width direction, and the vertical direction of the vehicle body.

The hybrid members 21, 31, 41, and 51 may be connected along the front-rear direction, vehicle width direction, and vertical direction of the vehicle body via a plurality of joint members 20c. The joint members 20c may, in one example, include aluminum extrusions.

The joint members 20c may connect the hybrid members 21, 31, 41, and 51 along the front-rear direction, vehicle width direction, and vertical direction of the vehicle body through fastening members such as bolts, nuts, rivets, FDS, or any combination thereof.

The hybrid members 21, 31, 41, and 51 according to a disclosed example embodiment of the present disclosure may include pillar hybrid members 21, roof side hybrid members 31, front roof hybrid member 41, and rear roof hybrid member 51.

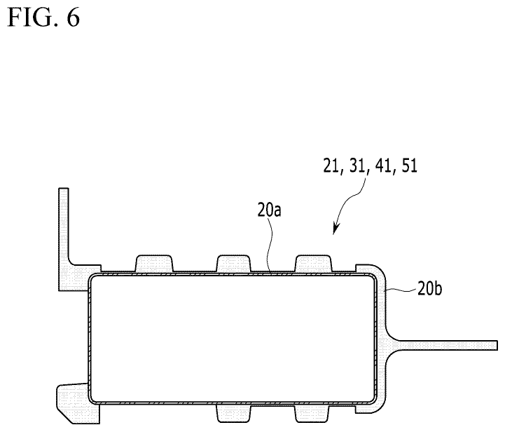

FIG. 6 is a cross-sectional view schematically illustrating a hybrid member applied to a cargo body assembly of a mobility according to a disclosed example embodiment of the present disclosure.

Each of the hybrid members 21, 31, 41, and 51 according to a disclosed example embodiment of the present disclosure may include a tubular part 20a of steel material, for example, having a closed cross-section, and an injection reinforcing material 20b of plastic material injection, for example, molded on an outer surface of the tubular part 20a as shown in FIG. 6.

The pillar hybrid members 21 can be connected along the vertical direction on both sides of the cargo under body 10 along the vehicle width direction and can be spaced apart along front-rear direction of the vehicle body.

For convenience of understanding, the pillar hybrid members 21 may include a front pillar, at least one center pillar, and a rear pillar. The pillar hybrid members 21 may be the A pillar, B pillar, C pillar, and D pillar used in the art, but are not necessarily limited thereto, and other pillars may be added.

Referring to FIG. 4, the pillar hybrid members 21 can be bolted to mounting brackets 11 mounted on both sides along the vehicle width direction of the cargo under body 10. The mounting brackets 11 can be connected by welding on both sides of the cargo under body 10 along the vehicle width direction and can be spaced apart along the front-rear direction of the vehicle body.

The mounting brackets 11 may be engaged with the lower portion of the pillar hybrid members 21 by use of bolts 22.

The roof side hybrid members 31 can be connected to the upper portions of the pillar hybrid members 21 along the front-rear direction of the vehicle body. The roof side hybrid members 31 may be connected to the upper part of the pillar hybrid members 21 by joint members 20c.

The front roof hybrid member 41 can be connected to the upper portion of pillar hybrid members 21 positioned forward of the cargo upper body 20 along the width direction of the vehicle body. The front roof hybrid member 41 may be connected to the upper portion of the pillar hybrid members 21 by joint members 20c.

The rear roof hybrid member 51 can be connected to the upper portion of pillar hybrid members 21 positioned at the rear of the cargo upper body 20 along the width direction of the vehicle body. The rear roof hybrid member 51 may be connected to the upper portion of the pillar hybrid members 21 by joint members 20c.

Referring to FIG. 2 to FIG. 5, in a disclosed example embodiment of the present disclosure, the reinforcement members 70 can be configured to reinforce the strength of the cargo upper body 20 and the strength of the outer plates 91, 93, and 95, which will be described later.

The reinforcement members 70 can be connected to the hybrid members 21, 31, 41, and 51 of the cargo upper body 20 along the front-rear direction of the vehicle body and the width direction of the vehicle body.

Referring to FIG. 2, FIG. 3 and FIG. 5, in a disclosed example embodiment of the present disclosure, the outer plates 91, 93, and 95 can be connected to the hybrid members 21, 31, 41, and 51 and the reinforcement members 70.

The outer plates 91, 93, and 95 may be, for example, plastic composite material panels that may help reduce the weight of the vehicle and do not necessarily require painting. The outer plates 91, 93, and 95 may be, in another example, glass fiber reinforced plastic (GFRP) panels.

In a disclosed example embodiment of the present disclosure, the outer plates 91, 93, and 95 may include a front outer plate 91, a side outer plate 93, and a roof outer plate 95.

The assemble structure of the cargo upper body 20, the reinforcement members 70, and the outer plates 91, 93, and 95 is described in detail with reference to the accompanying drawings.

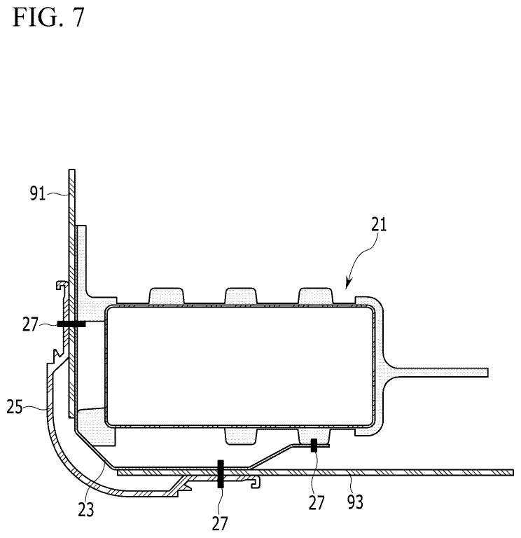

FIG. 7 is a cross-sectional view along line A-A of FIG. 2.

Referring to FIG. 2 and FIG. 7, the cargo upper body 20 according to a disclosed example embodiment of the present disclosure can include a front side reinforcement bracket 23 and a front side garnish member 25.

The front side reinforcement bracket 23 can be bonded to pillar hybrid members 21 positioned at the front by adhesive and can engage with the pillar hybrid members 21 by rivets 27. The front side reinforcement bracket 23 can be bonded to the front outer plate 91 and the side outer plate 93 by adhesive.

The front side garnish member 25 can be a garnish member made of aluminum material, for example, and can be engaged by the front outer plate 91, the side outer plate 93, and the front side reinforcement bracket 23 and rivets 27.

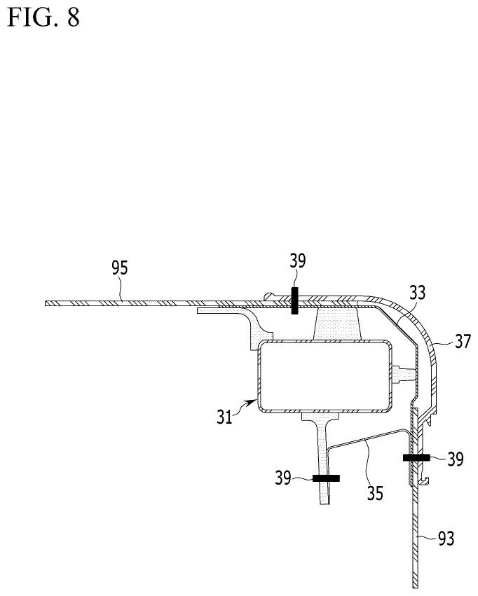

FIG. 8 is a cross-sectional view along line B-B of FIG. 2.

Referring to FIG. 2 and FIG. 8, the cargo upper body 20 according to a disclosed example embodiment of the present disclosure can include a roof side upper reinforcement bracket 33, a roof side lower reinforcement bracket 35, and a roof side garnish member 37.

The roof side upper reinforcement bracket 33 can be bonded to the roof side hybrid members 31 by adhesive, and to the side outer plate 93 and the roof outer plate 95 by adhesive.

The roof side lower reinforcement bracket 35 can be engaged to the roof side hybrid members 31 by rivets 39.

The roof side garnish member 37 can be a garnish member made of aluminum material, for example, and can be engaged to the roof side upper reinforcement bracket 33 and the roof outer plate 95 and rivets 39.

The roof side garnish member 37 can be engaged to the roof side upper reinforcement bracket 33, the roof side lower reinforcement bracket 35, and the side outer plate 93 by rivets 39.

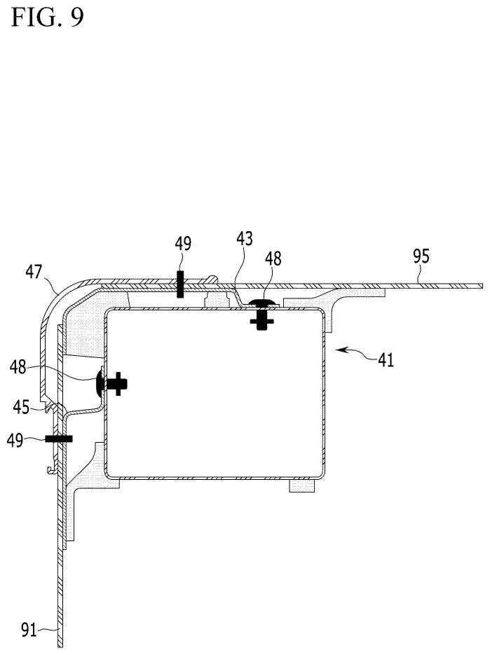

FIG. 9 is a cross-sectional view along line C-C of FIG. 2.

Referring to FIG. 2 and FIG. 9, the cargo upper body 20 according to a disclosed example embodiment of the present disclosure can include a front roof upper reinforcement bracket 43, a front roof lower reinforcement bracket 45, and a front roof garnish member 47.

The front roof upper reinforcement bracket 43 can be bonded to the front roof hybrid member 41 by adhesive and can engage the front roof hybrid member 41 by rivets 48. The front roof upper reinforcement bracket 43 can be attached to the roof outer plate 95 using adhesive.

The front roof lower reinforcement bracket 45 can be bonded to the front roof hybrid member 41 by adhesive and can engage the front roof hybrid member 41 by rivets 48. The front roof lower reinforcement bracket 45 can be attached to the front outer plate 91 with adhesive.

The front roof garnish member 47 can be a garnish member made of aluminum material, for example, and can be engaged by the roof outer plate 95 and the front roof upper reinforcement bracket 43 and rivets 49.

The front roof garnish member 47 can be engaged by the front outer plate 91 and the front roof lower reinforcement bracket 45 and rivets 49.

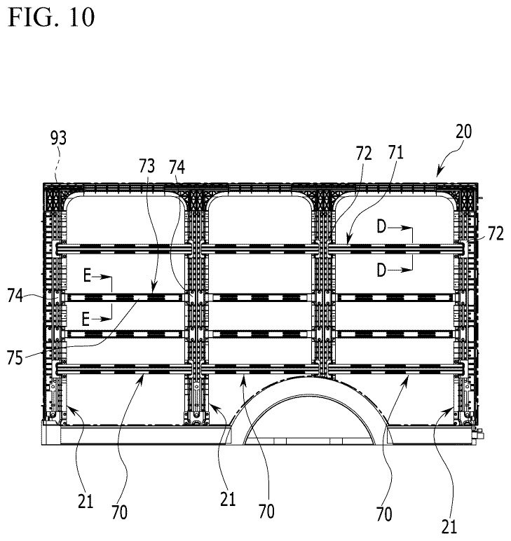

FIG. 10 is a side view illustrating a side reinforcing structure applied to a cargo body assembly of a mobility according to a disclosed example embodiment of the present disclosure.

Referring to FIG. 10, the reinforcement members 70 according to a disclosed example embodiment of the present disclosure can be configured to reinforce the side strength of the cargo upper body 20 and the strength of the side outer plate 93.

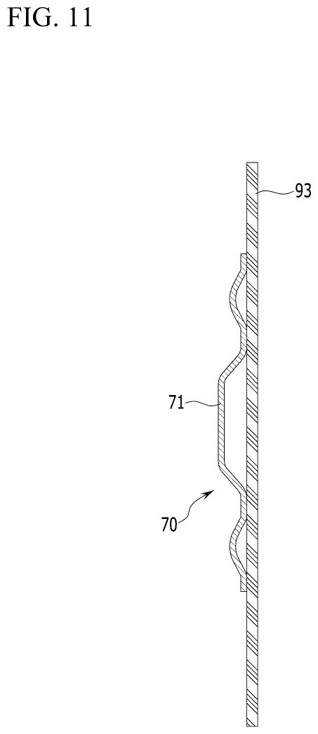

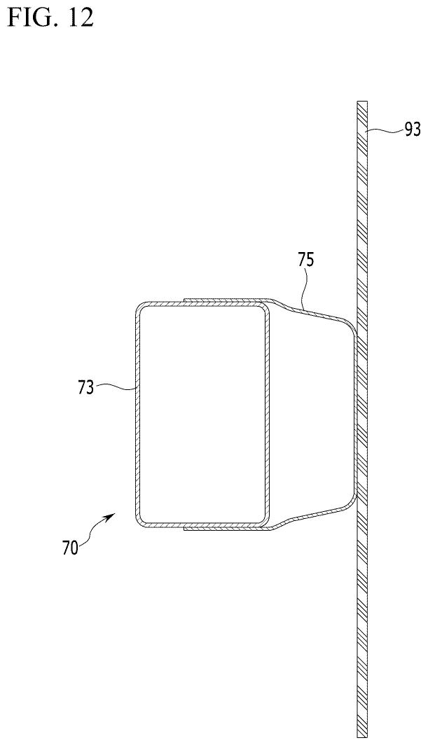

FIG. 11 is a cross-sectional view along line D-D of FIG. 10. FIG. 12 is a cross-sectional view along line E-E of FIG. 10.

Referring to FIG. 10 to FIG. 12, the reinforcement members 70 can include side reinforcement panels 71, side reinforcement pipes 73, and side support brackets 75.

The side reinforcement panels 71 can be panel parts press-formed into a set, selected, or predetermined shape and can be connected to the pillar hybrid members 21 along the front-rear direction of the vehicle body.

The side reinforcement panels 71 can be connected to the pillar hybrid members 21 via side panel joint brackets 72.

The side panel joint brackets 72 can be connected to each end of the side reinforcement panels 71, and may be engaged with the pillar hybrid members 21 by bolting, etc.

The side reinforcement pipes 73 can be tubular type pipe parts with a closed cross-section and can be connected to the pillar hybrid members 21 along the front-rear direction of the vehicle body.

The side reinforcement pipes 73 can be connected to the pillar hybrid members 21 through the side pipe joint brackets 74.

The side pipe joint brackets 74 can be connected to each end of the side reinforcement pipes 73 and may be engaged with the pillar hybrid members 21 by bolting, etc.

The side support bracket 75 can be connected to each of the side reinforcement pipes 73. The side support bracket 75 may be connected to the side reinforcement pipes 73 in a tight-fitting manner, may be connected to the side reinforcement pipes 73 in a bolting manner, or may be bonded to the side reinforcement pipes 73 by adhesive, for example.

The side outer plate 93 may be attached to the side reinforcement panels 71 and the side support bracket 75 using an adhesive.

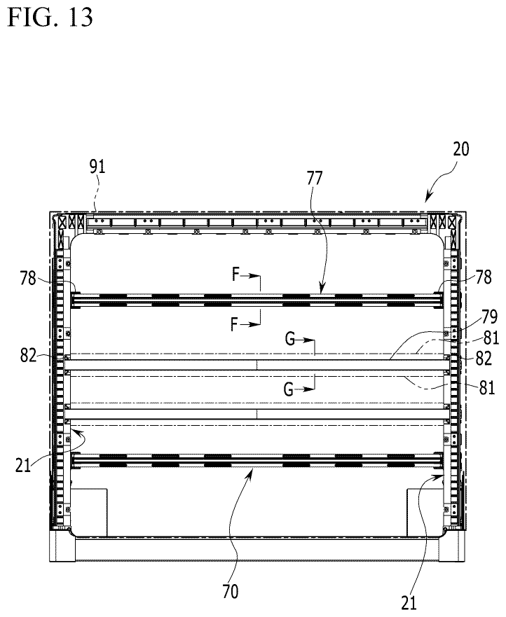

FIG. 13 is a front view illustrating a front reinforcing structure applied to a cargo body assembly of a mobility according to a disclosed example embodiment of the present disclosure.

Referring to FIG. 13, the reinforcement members 70 according to a disclosed example embodiment of the present disclosure can be configured to reinforce the front strength of the cargo upper body 20 and the strength of the front outer plate 91.

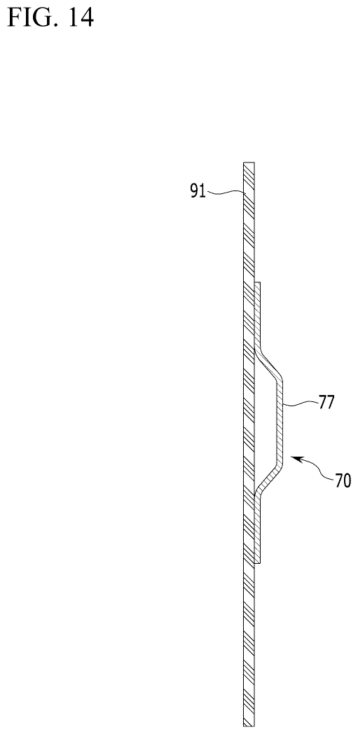

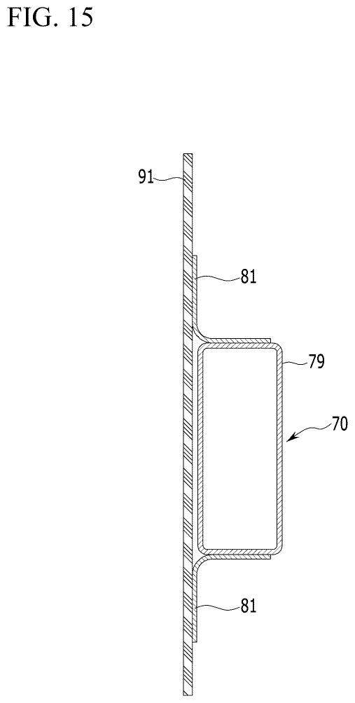

FIG. 14 is a cross-sectional view along line F-F of FIG. 13. FIG. 15 is a cross-sectional view along line G-G of FIG. 13.

Referring to FIG. 13 to FIG. 15, the reinforcement members 70 can include front reinforcement panels 77, front reinforcement pipes 79, and a front support bracket 81.

The front reinforcement panels 77 can be panel parts press-formed into a set, selected, or predetermined shape and can be connected to pillar hybrid members 21 positioned at the front along the width direction of the vehicle body.

The front reinforcement panels 77 can be connected to the pillar hybrid members 21 via the front panel joint brackets 78.

The front panel joint brackets 78 can be connected to each end of the front reinforcement panels 77 and may be engaged to the pillar hybrid members 21 by bolting, etc.

The front reinforcement pipes 79 can be tubular type pipe parts with a closed cross-section and can be connected to the pillar hybrid members 21 positioned at the front along the width direction of the vehicle body.

The front reinforcement pipes 79 can be connected to the pillar hybrid members 21 via the front pipe joint brackets 82.

The front pipe joint brackets 82 can be connected to each end of the front reinforcement pipes 79, and may be engaged to the pillar hybrid members 21 by bolting, etc.

The front support bracket 81 can be connected to the upper and lower portions of the front reinforcement pipes 79, respectively. The front support bracket 81 may be connected to the upper and lower portions of the front reinforcement pipes 79 by, for example, bolting, or may be bonded to the upper and lower portions of the front reinforcement pipes 79 by adhesive.

The front outer plate 91 may be adhesively attached to the front reinforcement panels 77 and the front support bracket 81.

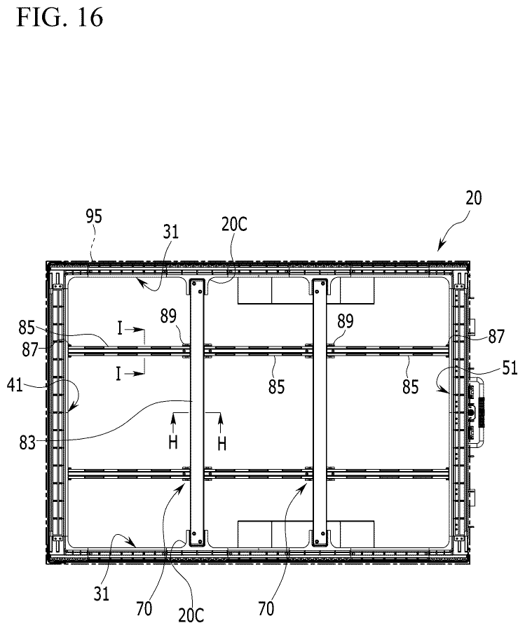

FIG. 16 is a top plan view illustrating a roof reinforcing structure applied to a cargo body assembly of a mobility according to a disclosed example embodiment of the present disclosure.

Referring to FIG. 16, the reinforcement members 70 according to a disclosed example embodiment of the present disclosure can be configured to reinforce the roof strength of the cargo upper body 20 and the strength of the roof outer plate 95.

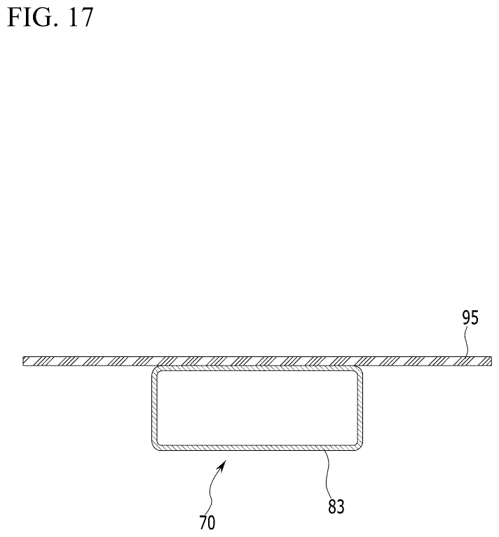

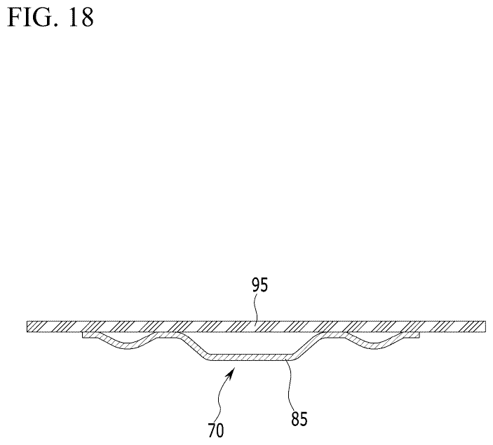

FIG. 17 is a cross-sectional view along line H-H of FIG. 16. FIG. 18 is a cross-sectional view along line I-I of FIG. 16.

Referring to FIG. 16 to FIG. 18, the reinforcement members 70 can include roof reinforcing pipes 83 and roof reinforcing panels 85.

The roof reinforcing pipes 83 can be tubular type pipe parts with a closed cross-section and can be connected to the roof side hybrid members 31 along the width direction of the vehicle body.

The roof reinforcing pipes 83 can be connected to the roof side hybrid members 31 via the joint members 20c. Both ends of the roof reinforcing pipes 83 may be connected to the joint member 20c through fastening members such as bolts, nuts, rivets, FDS, or any combination thereof.

The roof reinforcing panels 85 can be panel parts press-formed into a set, selected, or predetermined shape and can be connected to the front roof hybrid member 41 and the rear roof hybrid member 51 along the front-rear direction of the vehicle body.

The roof reinforcing panels 85 can be connected to the front roof hybrid member 41 and rear roof hybrid member 51 through the roof panel joint brackets 87.

The roof panel joint brackets 87 can be each connected to one end of a pair of roof reinforcing panels 85, and the other end of the roof reinforcing panels 85 may be connected to another roof reinforcing panel 85 via the connecting brackets 89.

The roof panel joint brackets 87 may be engaged to the front roof hybrid member 41 and the rear roof hybrid member 51 by bolting, etc. The connecting brackets 89 may be engaged, for example, by bolting, to one end of the roof reinforcing panels 85 and to both ends of another roof reinforcing panel 85.

The roof reinforcing pipes 83 and the roof reinforcing panels 85 may be bonded to the roof outer plate 95 by adhesive.

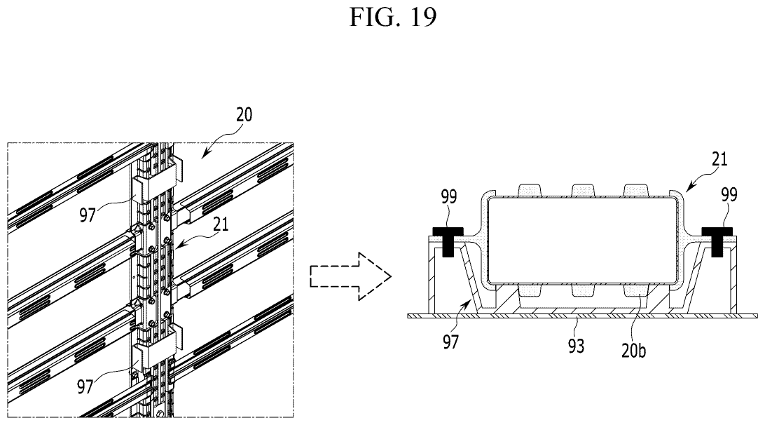

FIG. 19 is a drawing showing a joint structure of filler hybrid members and side outer plates applied to a cargo body assembly of a mobility according to a disclosed example embodiment of the present disclosure.

Referring to FIG. 19, the cargo upper body 20 according to a disclosed example embodiment of the present disclosure can include spacer members 97 connected to the pillar hybrid members 21.

The spacer members 97 may be interposed in the separation space between the pillar hybrid members 21 and the side outer plate 93. The spacer members 97 can be bonded to the side outer plate 93 by adhesive.

The spacer member 97 can fit into the groove portion of the injection reinforcing material 20b of the pillar hybrid members 21 and may be engaged with the injection reinforcing material 20b by bolts 99.

In FIG. 2, a rear door 15 may be movably mounted on a door frame 17 connected to the rear of the cargo upper body 20. The door frame 17 may be connected to the pillar hybrid members 21 and the rear roof hybrid member 51 positioned at the rear of the cargo upper body 20.

For a cargo body assembly of a mobility 100 according to a disclosed example embodiment of the present disclosure, the cargo upper body 20 can be provided having the cargo under body 10 and the hybrid members 21, 31, 41, and 51 in which the injection reinforcing material 20b is formed on an outer surface of the tubular part 20a.

A cargo body assembly of a mobility 100 according to a disclosed example embodiment of the present disclosure can include the reinforcement members 70 of panel type and pipe type connected to the hybrid members 21, 31, 41, and 51.

A cargo body assembly of a mobility 100 according to a disclosed example embodiment of the present disclosure can provide a structure in which the outer plates 91, 93, and 95 of plastic composite material can be bonded to the hybrid members 21, 31, 41, and 51 and the reinforcement members 70.

A cargo body assembly of a mobility 100 according to a disclosed example embodiment of the present disclosure can provide a structure in which the cargo under body 10, the cargo upper body 20, the reinforcement members 70, and the outer plates 91, 93, and 95 can be assembled with fastening members (or hardware) and adhesive.

Therefore, processes such as pressing, painting, welding, or any combination thereof, are not necessarily required to assemble the cargo body assembly of a mobility 100 according to a disclosed example embodiment of the present disclosure.

Because a cargo body assembly of a mobility 100 according to a disclosed example embodiment of the present disclosure may be assembled in an automated process on an assembly line, mass production of the cargo body assembly can be possible.

A cargo body assembly of a mobility 100 according to a disclosed example embodiment of the present disclosure can secure the body rigidity of the front, side, and roof, and can secure the strength of the outer plates 91, 93, and 95.

For a cargo body assembly of a mobility 100 according to a disclosed example embodiment of the present disclosure, the reinforcement brackets 23, 33, 35, 43, and 45 can be mounted on edge portions (e.g., corner portions) of the hybrid members 21, 31, 41, and 51 of the cargo upper body 20.

Accordingly, a cargo body assembly of a mobility 100 according to a disclosed example embodiment of the present disclosure can secure the body connectivity of the cargo upper body 20 and the joint strength of the cargo upper body 20 and the outer plates 91, 93, and 95.

A cargo body assembly of a mobility 100 according to a disclosed example embodiment of the present disclosure can easily disperse the load (e.g., torsional load, tensile load) transmitted to the outer plates 91, 93, and 95 through the cargo under body 10, the cargo upper body 20, and the reinforcement members 70.

While the present disclosure has been described in connection with what is presently considered to be practical example embodiments, it can be understood that the present disclosure is not necessarily limited to the disclosed embodiments. On the contrary, the present disclosure is intended to cover various modifications and equivalent arrangements included within the spirit and scopes of the appended claims.

What is claimed is:

1. A cargo body assembly of a mobility comprising:
a cargo under body configured to be connected to a vehicle body;
a cargo upper body connected to the cargo under body, and the cargo upper body comprises cargo-upper-body hybrid members, wherein each of the cargo-upper-body hybrid members comprises an injection reinforcing material molded on an outer surface of a tubular part, wherein the cargo-upper-body hybrid members are disposed along a front-rear direction, a vehicle width direction, and a vertical direction of the vehicle body;
reinforcement members connected to the cargo upper body along the front-rear direction and the vehicle width direction of the vehicle body; and
outer plates comprising a plastic composite material connected to the cargo upper body and the reinforcement members.

2. The cargo body assembly of claim 1, wherein the cargo-upper-body hybrid members are connected to each other by a plurality of joint members.

3. The cargo body assembly of claim 1, wherein the cargo-upper-body hybrid members comprise:
pillar hybrid members disposed along the vertical direction on both sides of the cargo under body along the vehicle width direction of the vehicle body and arranged along the front-rear direction of the vehicle body;
roof side hybrid members connected along the front-rear direction of the vehicle body to first upper portions of the pillar hybrid members;
a front roof hybrid member connected along the vehicle width direction to second upper portions of the pillar hybrid members positioned at a front side of the vehicle body; and
a rear roof hybrid member connected along the vehicle width direction to third upper portions of the pillar hybrid members positioned at a rear side of the vehicle body.

4. The cargo body assembly of claim 1, wherein the cargo-upper-body hybrid members comprise pillar hybrid members disposed along the vertical direction on both sides of the cargo under body along the vehicle width direction and arranged along the front-rear direction of the vehicle body; and
wherein the pillar hybrid members are bolted to mounting brackets mounted on both sides along the vehicle width direction of the cargo under body.

5. The cargo body assembly of claim 1, wherein the outer plates comprise a front outer plate and a side outer plate and wherein the cargo upper body comprises:
pillar hybrid members of the cargo-upper-body hybrid members disposed along the vertical direction on both sides of the cargo under body along the vehicle width direction and arranged along the front-rear direction of the vehicle body,
a front side reinforcement bracket riveted to one of the pillar hybrid members positioned at a front side of the vehicle body and bonded to the front outer plate and the side outer plate, and
a front side garnish member rivetted and connected to the front outer plate, the side outer plate, and the front side reinforcement bracket.

6. The cargo body assembly of claim 1, wherein the outer plates comprise a roof outer plate and a side outer plate and wherein the cargo upper body comprises: pillar hybrid members of the cargo-upper-body hybrid members disposed along the vertical direction on both sides of the cargo under body along the vehicle width direction and arranged along the front-rear direction of the vehicle body,
roof side hybrid members of the cargo-upper-body hybrid members connected to upper portions of some of the pillar hybrid members along the front-rear direction of the vehicle body,
a roof side upper reinforcement bracket bonded to one of the roof side hybrid members and bonded to the roof outer plate and the side outer plate,
a roof side lower reinforcement bracket connected to the one of the roof side hybrid members, and
a roof side garnish member connected to the roof side upper reinforcement bracket and the roof outer plate by at least one first rivet, and connected to the roof side upper reinforcement bracket, the roof side lower reinforcement bracket, and the side outer plate by at least one second rivet.

7. The cargo body assembly of claim 1, wherein the outer plates comprise a roof outer plate and a front outer plate and wherein the cargo upper body comprises:
pillar hybrid members of the cargo-upper-body hybrid members disposed along the vertical direction on both sides of the cargo under body along the vehicle width direction and arranged along the front-rear direction of the vehicle body,
roof side hybrid members of the cargo-upper-body hybrid members connected to first upper portions of the pillar hybrid members along the front-rear direction of the vehicle body,
a front roof hybrid member connected along the vehicle width direction to second upper portions of the pillar hybrid members positioned at a front side of the vehicle body,
a front roof upper reinforcement bracket bolted connected to the front roof hybrid member and adhered to the roof outer plate,
a front roof lower reinforcement bracket bolted connected to the front roof hybrid member and bonded to the front outer plate, and
a front roof garnish member rivetted and connected to the roof outer plate and the front roof upper reinforcement bracket, and rivetted and connected to the front outer plate and the front roof lower reinforcement bracket.

8. The cargo body assembly of claim 1, wherein the cargo-upper-body hybrid members comprise pillar hybrid members disposed along the vertical direction on both sides of the cargo under body along the vehicle width direction and arranged along the front-rear direction of the vehicle body; and
wherein the reinforcement members comprise side reinforcement panels and side reinforcement pipes connected to the pillar hybrid members along the front-rear direction of the vehicle body.

9. The cargo body assembly of claim 8, wherein the side reinforcement panels are connected to the pillar hybrid members through side panel joint brackets; and
wherein the side reinforcement pipes are connected to the pillar hybrid members through side pipe joint brackets.

10. The cargo body assembly of claim 8, wherein the reinforcement members further comprise side support brackets connected to each of the side reinforcement pipes, respectively.

11. The cargo body assembly of claim 10, wherein the outer plates comprise a side outer plate bonded to at least some of the side reinforcement panels and the side support brackets.

12. The cargo body assembly of claim 1, wherein the cargo-upper-body hybrid members comprises pillar hybrid members disposed along the vertical direction on both sides of the cargo under body along the vehicle width direction and arranged along the front-rear direction of the vehicle body; and
wherein the reinforcement members comprise front reinforcement panels and front reinforcement pipes connected along the vehicle width direction to a front set of the pillar hybrid members positioned at a front side of the vehicle body.

13. The cargo body assembly of claim 12, wherein the front reinforcement panels are connected to the front set of the pillar hybrid members by front panel joint brackets; and
wherein the front reinforcement pipes are connected to the front set of the pillar hybrid members by front pipe joint brackets.

14. The cargo body assembly of claim 12, wherein the reinforcement members further comprise front support brackets connected to upper and lower portions of each of the front reinforcement pipes, respectively.

15. The cargo body assembly of claim 14, wherein the outer plates comprise a front outer plate bonded to the front support brackets.

16. The cargo body assembly of claim 3, wherein the reinforcement members comprise:
roof reinforcing pipes connected to the roof side hybrid members along the vehicle width direction; and
roof reinforcing panels connected to the front roof hybrid member and the rear roof hybrid member along the front-rear direction of the vehicle body.

17. The cargo body assembly of claim 16, wherein the outer plates comprise a roof outer plate; and
wherein the roof outer plate is bonded to the roof reinforcing pipes and the roof reinforcing panels.

18. The cargo body assembly of claim 1, wherein the outer plates comprise side outer plates and wherein the cargo upper body comprises:
pillar hybrid members of the cargo-upper-body hybrid members disposed along the vertical direction on both sides of the cargo under body along the vehicle width direction and arranged along the front-rear direction of the vehicle body; and
spacer members connected to at least some of the pillar hybrid members and bonded to the side outer plates.

19. The cargo body assembly of claim 18, wherein the spacer members are inserted into the injection reinforcing material of the pillar hybrid members and are bolted connected to the injection reinforcing material.

20. A purpose-based mobility comprising:
a vehicle body; and
a cargo body assembly removably connected to the vehicle body, wherein the cargo body assembly comprises:
a cargo under body removably connected to the vehicle body,
a cargo upper body connected to the cargo under body, and the cargo upper body comprises cargo-upper-body hybrid members, wherein each of the cargo-upper-body hybrid members includes injection reinforcing material molded on an outer surface of a tubular part, wherein the cargo-upper-body hybrid members are disposed along a front-rear direction, a vehicle width direction, and a vertical direction of the vehicle body,
reinforcement members connected to the cargo upper body along the front-rear direction and the vehicle width direction of the vehicle body, and
outer plates including plastic composite material connected to the cargo upper body and the reinforcement members by at least one of adhesive, rivets, or bolts; and
wherein the cargo-upper-body hybrid members comprise:
pillar hybrid members disposed along the vertical direction on both sides of the cargo under body along the vehicle width direction of the vehicle body and arranged along the front-rear direction of the vehicle body,
roof side hybrid members connected along the front-rear direction of the vehicle body to first upper portions of the pillar hybrid members,
a front roof hybrid member connected along the vehicle width direction to second upper portions of the pillar hybrid members positioned at a front side of the vehicle body, and
a rear roof hybrid member connected along the vehicle width direction to third upper portions of the pillar hybrid members positioned at a rear side of the vehicle body.
